(19) United States
(12) Patent Application Publication
(10) Pub. No.: US 2009/0151534 A1
(43) Pub. Date: Jun. 18, 2009

(54) Slitter Line Knife Holder Assembly

(76) Inventors: C. Aldon Rooke, Burlington (CA); Joseph Kwadjo Konney, Hamilton (CA); Steven Zayeri, Toronto (CA); Wenzhao Lan, Mississauga (CA); Vasile Radu Verdes, Etobicoke (CA)

Correspondence Address: GOWAN INTELLECTUAL PROPERTY, 1075 NORTH SERVICE ROAD WEST, SUITE 203, OAKVILLE, ON, L6M-2G2, CA

(21) Appl. No.: 12/267,418

(22) Filed: Nov. 7, 2008

Related U.S. Application Data
(60) Provisional application No. 60/986,886, filed on Nov. 9, 2007.

(51) Int. Cl. B26D 1/12

(52) U.S. Cl. 83/663

(57) ABSTRACT

A hydraulic knife holder for a slitting machine is provided which includes a first fluid chamber for exerting pressure on the inner surface of a hydraulic holder, and a secondary fluid chamber in operative contact with the first fluid chamber, and which is connected to a movable piston which can be moved to increase or decrease the pressure within the first and second chambers. By movement of the piston, the inner diameter of the holder can be adjusted so as to cause the holder to be locked onto the arbors of the slitting machine, or released from the arbor. No fluid is lost from the system during adjustment, and the holder is particularly well suited for adjustment using an automated knife positioning system.

### RELATED APPLICATIONS

This application claims the benefit of priority under 35 U.S.C. §119(e) to U.S. Provisional Application Ser. No. 60/986,886 filed on Nov. 9, 2007, the entirety of which is hereby incorporated by reference.

### FIELD OF THE INVENTION

The present invention relates to the field of knives for use on slitter machines used for slitting metal strips into smaller “mults” or strips, and more particularly, to the holders used to hold the knives in position on the slitter machines.

### BACKGROUND OF THE INVENTION

Much of the metal produced by mills is in the form of coiled strip, but rarely does the strip correspond in width to the multitude of products that are stamped or otherwise formed from it. Accordingly, the metal strip is usually slit longitudinally to various smaller sizes which are suitable for the particular products. Indeed, special slitting machines are made for this purpose.

The typical slitting machine, or “slitter”, has circular blades or knives arranged in pairs on two powered shafts or arbors, there being one of a mated pair of knives on each arbor. The arbors are connected to a drive system for counter-rotation. During operation, sheet metal is moved between the arbors and cut into strips, or “mults”, by the knives counter-rotating on the arbors. Actually each knife is nothing more than a hardened steel disk having flat end faces and a cylindrical peripheral face which intersects the end faces at relatively sharp cutting or shearing edges. The disks of each pair of knives are positioned on their respective arbors, often with a slight overlap. Overlap or not, the knives of each pair are positioned close enough to each other to enable them to cut or shear the metal sheet as it passes between those knives. In other words, the metal strip is drawn between the two knives of a pair, and the disk-like knives shear the strip along the opposite cutting edges, thus producing a clean longitudinal cut in the strip.

The size of the mults is determined by the spacing of the knives on the arbors.

The knives, while being fixed firmly on their respective arbors during the operation of the machine, nevertheless may be removed for sharpening, or may be repositioned so that the width of the mults may be varied. Setting the knives on the arbors of a slitting machine however is a tedious and time-consuming procedure, requiring a high degree of skill, for the knives must be located with considerable precision, not only to acquire the proper width for the cut, but to also maintain a clean high quality cut as well.

Further, after the knives have been located on the arbors, they must be fastened to, or otherwise connected to the arbor in such a fashion that they rotate with the arbor while the cutting process occurs. Slippage of a knife blade, held within a knife or blade holder, or slippage of the holder, is to be avoided since this can damage the knife, holder or arbor, and cause the blade to wobble, or cause the blade to cut incorrect mult widths.

In one prior art approach to holding the knife holder, and thus the knife, in position, the arbor is a thin walled arbor in which the outer surface of the arbor can be slightly expanded so as to increase the arbor's outer diameter. This will allow it to engage and hold the inside diameter of a closely fitted knife blade holder. However, this option requires a specialized arbor to be produced at significantly increased cost. Further, if a blade holder is over-tightened, or remains in place on the arbor for an extended period, it is possible to form recesses on the arbor in which the holder rests. It is then physically difficult to move the holder to other locations on the arbor, and damage of the arbor can occur as the holder is forced into a new position.

In another approach, the arbor is a solid arbor that maintains a constant diameter. In this approach, the knife holder has a inner surface which can be mechanically contracted by twisting of an adjustment bolt, or the like. Typically, this type of holder has a series of rib like projections on its inner surface which allow the inside diameter to be varied, and these rib like projections will be pressed inwards towards the arbor.

However, with these mechanical attachment means, the final locking adjustment can cause the knife blade to twist slightly as it is being tightened. This can lead to the knife blade not being perpendicular to the arbor and not being perpendicular to the travel direction of the strip to be cut. This causes wobble in the blade and again, can cause damage to the blade, the holder, the arbor and/or to the material being cut.

To avoid this incorrect alignment and/or position, the arbor can also be fitted with a variety of spacers or shims which are used to hold the blade in the proper position on the arbor, as well as hold the blade in the desired alignment. These spacers and shims are large enough and are machined with enough precision to minimize the wobble inherent with this approach, but can present complexities in the selection of spacers and shims to properly locate the knives. Moreover, selection of spacers and shims requires a considerable amount of skill, and positioning of the blades within a series of spacers is a time consuming operation. Further, a trained machinist is required in order to ensure that the holders, blades, spacers, shims and arbors are all correctly placed and positioned without incurring any damage to these devices, including nicks and scratches which might affect the balance and wobble of the spinning devices.

A more recent approach, however, has been to use a hydraulic blade holder in which a thin membrane on the inner surface of the blade holder is caused to expand so as to decrease the inner diameter of the blade holder, and thus, clamp onto the solid arbor. This is achieved by providing a thin metal membrane on the inner surface of the blade or knife holder, and expanding the membrane by increasing the hydraulic pressure within a hollow chamber located behind the membrane. Locking of the knife or blade holder is achieved by pressurizing the fluid contained within the chamber, to cause the membrane to flex outward, and thus, reduce the inner diameter of the knife holder. This causes the holder to clamp onto the circular, solid arbor.

Typically, the preferred fluid to be used is grease which has been injected into, and fills the chamber. The clamping force of the holder onto the arbor can be adjusted by adjusting the pressure within the chamber.

Typically, the chamber pressure is increased by attaching a specific grease gun, or the like, to a nipple located on the holder, and using the grease gun to increase the pressure within the chamber. Pressures of approximately 300 bar, or higher are used to lock the holder in place on the arbor. The pressure can be released by opening a socket set screw and ball assembly which allows some of the grease to be released from the chamber. However, this grease must be collected so as to avoid contamination of the metal strip, or arbor surface, or the like.

Again, however, this approach requires a skilled machinist to locate the blades and/or blade holders in a specific location, and requires the machinist to use a specific tool or tools to lock or release the holder from the arbor.

Accordingly, it would still be advantageous to provide a knife or blade holder which could be rapidly locked to, or released from, a solid arbor, and which was designed so as to facilitate the adoption of a more automated method for positioning and locking of a knife or blade holder on the arbor.

### SUMMARY OF THE INVENTION

The present invention overcomes the foregoing and other shortcomings and drawbacks of current blade or knife holders heretofore known. While the invention will be described in connection with certain embodiments, it will be understood that the invention is not limited to these embodiments. On the contrary, the invention includes all alternatives, modifications and equivalents as may be included within the spirit and scope of the present invention.

The advantages set out hereinabove, as well as other objects and goals inherent thereto, are at least partially or fully provided by the knife holder of the present invention, as set out herein below.

Accordingly, in one aspect, the present invention provides a knife holder for use on an preferably solid arbor, wherein the knife holder comprises a annular housing adapted to be fitted around a circular arbor, which holder has a hydraulic membrane on an inner surface thereof, which membrane is utilized to decrease or increase the inner diameter of the holder by increasing or decreasing the pressure with a fluid-filled first chamber located operatively adjacent to the membrane, and additionally comprising a pressure adjustment piston and adjustment set screw, located within a transversely positioned second fluid filled chamber, operatively connected to the first chamber, whereby, pressure within the first and second chamber is adjusted by movement of the set screw to effect movement of the piston so as to increase or decrease the pressure within the first and second chambers, and thus cause the inner diameter of the inner surface of the holder to increase or decrease.

The second chamber is located essentially transversely to a radially extending line drawn from the centre of the holder. A counterbored access port or opening is provided for ease of access to the set screw.

With this arrangement, the pressure within the first and second chambers can be adjusted by one tool, and it is no longer necessary to release fluid from the holder chamber, in order to release the pressure. Accordingly, any issues with collection of released grease, or other fluids, from the holder is eliminated.

Further, since only a single tool is required for adjustment of the pressure, and since no fluid is lost from the holder, the holder of the present invention is particularly well suited for devices wherein the holder is positioned automatically through the use of positioning equipment. As such, in a preferred embodiment, the holder of the present invention also includes positioning tool attachment means, such as slots, grooves, openings, or the like, in which a holder locating arm of the positioning equipment can be fitted.

The size and shape of the first and second chamber can be modified depending on the size, shape and design characteristics of the holder. For example, a larger diameter knife holder might require a larger first chamber to apply sufficient force to lock the holder in place, as would be currently known in the art. In the present invention, however, the number and size of second chambers can be designed so as to be able to provide the necessary piston movement to create the pressure required in the first chamber.

For a given holder, the number of movable pistons and second chambers can vary, but typically will be between 1 and 4, and most typically, will be 2 second chambers, located on opposite sides of the holder.

### DETAILED DESCRIPTION OF THE INVENTION

In the present application, the term “holder” refers to a device to be fitted to an arbor of a slitting machine. As such, the present application is primarily directed to the use of a slitter to slit a metal strip, such as a steel strip or the like, into a plurality of smaller strips of a desired width. However, the skilled artisan will be aware that slitters are used to slit other materials, such as paper, cardboard, or the like, and thus, the holder of the present invention, can be used in a wide variety of applications.

Further, while the holder is described herein with particular reference to a knife holder, it can equally as well be used in combination with other devices to be fitted to an arbor which are known within this industry. This includes devices such as stripper rings or plates, support spacers or the like, as well as any other devices which are to be temporarily fitted to an arbor.

Accordingly, while the present application is described with particular reference to the a knife holder which is used slit a metal strip into mults, the skilled artisan would be aware that the present application is equally applicable in a variety of other applications.

Further, unless otherwise specifically noted, all of the features described herein may be combined with any of the above aspects, in any combination.

### BRIEF DESCRIPTION OF THE DRAWINGS

Embodiments of this invention will now be described by way of example only in association with the accompanying drawings in which:

FIG. 1 is a cross-sectional drawing of a prior art hydraulic membrane knife holder;

FIG. 2 is a perspective, exploded view of a knife holder of the present invention;

FIG. 3 is a cut-away, cross-sectional drawing of a section of the knife holder of the present invention showing the details of construction of the second chamber; and

FIG. 4 is a side view of a holder of the present invention.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example only. In the drawings, like reference numerals depict like elements.

It is expressly understood, however, that the drawings are for the purpose of illustration and description only and are not intended as a definition of the limits of the invention.

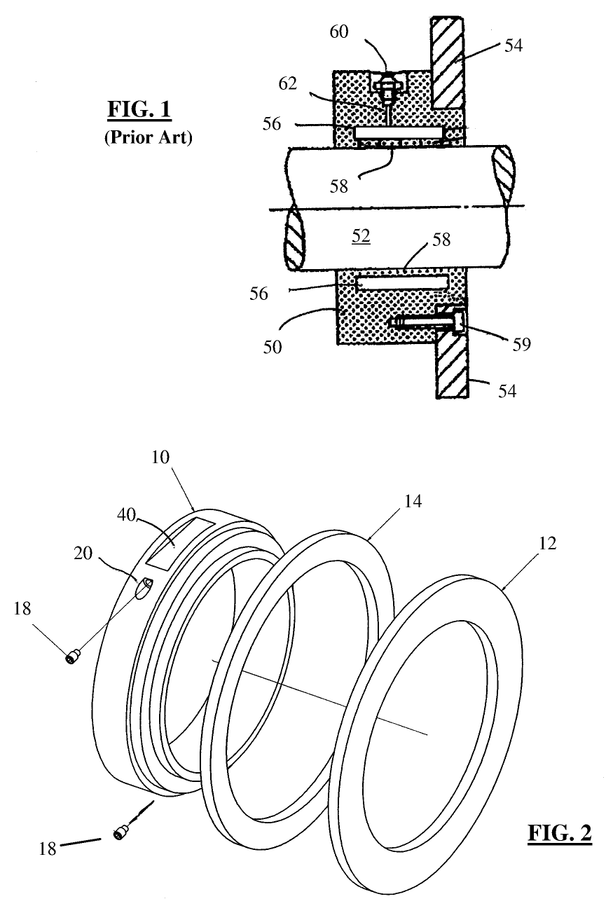

Referring to FIG. 1, a prior art hydraulic blade holder 50 having an annular construction is shown which has been attached to, and fitted around a solid arbor 52. A knife (or blade) 54 is attached to holder 50 using bolts 59 spaced around knife 54. A grease filled annular chamber 56 extends around holder 50, and bears pressure against membrane 58 which is in operative contact with arbor 52. A recessed grease nipple 60 is provided within the outer surface of holder 50, and is in operative contact with chamber 56 through tube 62.

In this example, arbor 52 has an outside diameter of 55 mm, and holder 50 has a nominal inside diameter of slightly more than 55 mm, but can be decreased to less than 55 mm, by expansion of membrane 58, as described hereinbelow. The arbor can be any suitable size, but typically is between 50 and 500 mm. Holder 50 has an outside diameter of 125 mm, and knife 54 has an outside diameter of 180 mm. These values can vary however, depending on a variety of factors including the design parameters of the slitter, the material to be cut, and the like.

In operation, holder 50 is slid onto the end of arbor 52 and moved to a desired location. Once in position, a specialized grease gun such as an Amtec Handpump, available from Amtec Hydraclamp Inc., is connected to nipple 60, and grease is added so as to increase the pressure within chamber 56 to 300 bar (4,350 psi). This pressure causes membrane 58 to expand outward, and thus, cause an overall decrease in the inner diameter of holder 50. As a result, holder 50 becomes locked on to arbor 52, and further movement of holder 50, either laterally along the arbor, or rotationally around the arbor, is prevented until the pressure is released by partially unscrewing opening a release screw (not shown).

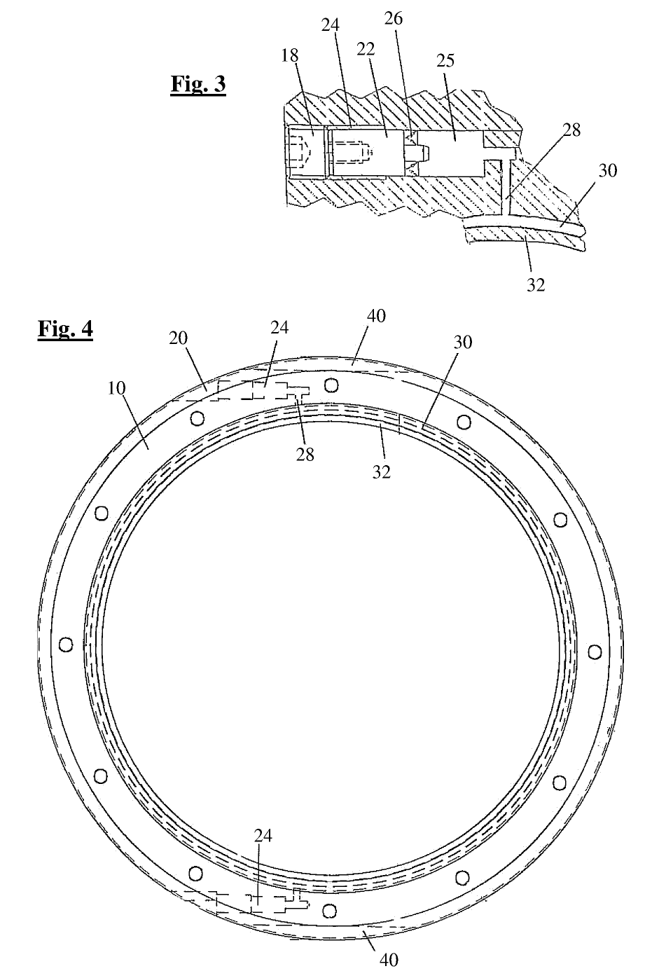

In FIG. 2, a perspective, partially exploded view of a hydraulic holder 10 according to the present invention, is shown. Holder 10 is adapted to hold a blade 12, and a stripper ring 14, and is adapted to be fitted around a solid arbor (not shown) in the same manner as holder 50. Blade 12 and stripper ring 14 are adapted to be bolted to one side of holder 10. Holder 10 also includes two counterbored openings or ports 20 on opposite sides of holder 10, and a set screw 18 is fitted into each port 20. From FIG. 3, it can be seen that each set screw 18 is operatively connected to piston 22, which is sealed within second chamber 24, using seals 26. Second chamber 24 is located in a manner which is essentially traverse to a radial line extending outwards from the centre of holder 10. Second chamber 24 also includes a fluid reservoir 25, which is operatively connected to first chamber 30 through tube 28. First chamber 30 extends around holder 10, and applies pressure against membrane 32 located on the inner surface of holder 10. In the same manner as in holder 50, pressure against membrane 32 of holder 10, locks holder 10 in position on the arbor.

The outer surface of membrane 32 forms the inner surface of holder 10.

In this embodiment, piston 22 and set screw 18 both have a length of 10 mm, and reservoir 25 also has a nominal length of 10 mm, leading to a total length of second chamber 24, at 30 mm. The length and diameter of set screw 18 and piston 22 can also vary, but preferably at both between 5 and 15 mm.

Additional space is provided for counterbored opening 20.

From FIG. 4, it can be seen that two separate second chambers 24 are provided on holder 10. Chambers 24 are essentially on opposite sides of holder 10, but the counterbored openings 20 are directed in the same direction. As such, access to both counterbored openings 20 can be gained from one side of holder 10. Other design possibilities are possible, however.

In FIGS. 2 to 4, a slot 40 is provided which is adapted to receive a locating arm from a holder positioning system, of the type described in our co-pending US application, namely 60/986,892, the contents of which are incorporated by reference.

As described in that application, the locating arm of the holder positioning system is inserted into slots 40 located on each side of holder 10. The holder positioning system is moved to effect movement of blade 12 to a desired location on the arbor. Holder tightening tools (not shown) are then automatically extended from the holder positioning system and is inserted into counterbored openings 20 so as to gain access to, and turn set screws 18 in order to increase (or alternatively decrease) the pressure within reservoir 25, and thus also within, first chamber 30.

For clarity, both chambers 24 (and reservoirs 25) are operatively connected to a single, common first chamber 30 which extends around the inner surface of holder 10.

A preferred feature of the present invention is that the second chamber has an essentially traverse orientation. This allows sufficient distance for the piston 22 and set screw 18 to move, in addition to the second chamber provision of a second chamber fluid reservoir 25. Typically, the holder 10 is not thick enough to provide sufficient space for a radially mounted assembly of this type, and as such, a transverse relationship allows sufficient space for these design considerations.

In alternative embodiments, the set screw and piston can be provided as a single item, and the length and position of tube 28 can be varied accordingly.

The materials used for construction of the holder, arbor, blade, stripper ring, and the like, are all essentially the same as current devices, and thus, the skilled artisan would be able to determine suitable materials for these devices. Typically, though, the arbor, holder and blade are made of steel.

The nominal inner diameter of holder 10 is closely matched to the outer diameter of the arbor. Preferably, the arbor is ground to close tolerances, and is preferably chrome plated. The nominal inner diameter of holder 10 is preferably between 0.00001 and 0.001 inch greater than the outer diameter of the arbor, although these value range can vary. Typically, the smaller the difference between the outer diameter of the arbor, and the nominal inner diameter of the knife holder, the less likely there will be any wobble of the knife blade. As such, this difference should be made as small as possible, while still allowing free movement of the knife holder along the arbor when the knife holder is un-locked.

Further, holder 10 is preferably as wide as possible, under the design considerations of the slitter, in order to further promote stability of the knife and holder.

Still further, membrane 30 preferably extends across greater than 50%, and more preferably, greater than 75% of the width of holder 10, in order that the clamping force from membrane 30 is exerted across a larger area. Further, this arrangement provides an even and constant expansion of the membrane, and therefore also provides even and constant pressure on the arbor. The pressure with the chambers can also vary depending on the knife holder design parameters, but typically will be between 300 and 700 bar in order to effectively hold the knife holder in place.

Again, as noted above with respect to the prior art, in a typical slitter, a number of cooperating blade pairs are fitted to each of two arbors, and the strip of material to be cut is fed between an upper and lower arbors. The holders of the present invention can therefore be used to hold the cutting knives on either of the upper and lower arbors. As such, a plurality of knives and corresponding holders, can be provided on each arbor.

Thus, it is apparent that there has been provided, in accordance with the present invention, a holder which fully satisfies the goals, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps.

Moreover, the words “substantially” or “essentially”, when used with an adjective or adverb is intended to enhance the scope of the particular characteristic; e.g., substantially planar is intended to mean planar, nearly planar and/or exhibiting characteristics associated with a planar element.

Further, use of the terms “he”, “him”, or “his”, is not intended to be specifically directed to persons of the masculine gender, and could easily be read as “she”, “her”, or “hers”, respectively.

Also, while this discussion has addressed prior art known to the inventor, it is not an admission that all art discussed is citable against the present application.

We claim:

1. A knife holder for use on an preferably solid arbor, wherein the knife holder comprises a annular housing adapted to be fitted around a circular arbor, which holder has a hydraulic membrane on an inner surface thereof, which membrane is utilized to decrease or increase the inner diameter of the holder by increasing or decreasing the pressure with a fluid-filled first chamber located operatively adjacent to the membrane, and additionally comprising a pressure adjustment piston and adjustment set screw, located within a transversely positioned second fluid filled chamber, operatively connected to the first chamber, whereby, pressure within the first and second chamber is adjusted by movement of the set screw to effect movement of the piston so as to increase or decrease the pressure within the first and second chambers, and thus cause the inner diameter of the inner surface of the holder to increase or decrease.

2. A knife holder as claimed in claim 1 wherein said second chamber is located essentially transversely to a radially extending line drawn from the centre of the holder.

3. A knife holder as claimed in claim 1 wherein a counterbored access port or opening is provided for access to the set screw.

4. A knife holder as claimed in claim 1 wherein said holder additionally comprises positioning tool attachment means adapted to be connected to a holder positioning equipment.

5. A knife holder as claimed in claim 4 wherein said attachment means comprise slots, grooves, openings, or the like, in which a holder locating arm of the positioning equipment can be fitted.

6. A knife holder as claimed in claim 1 comprising two second chambers located on opposite sides of the holder.
